(19) United States
(12) Patent Application Publication
(10) Pub. No.: US 2014/0301163 A1
(43) Pub. Date: Oct. 9, 2014

(54) MARINE SEISMIC VARIABLE DEPTH CONTROL METHOD AND DEVICE

(71) Applicant: WESTERNGECO L.L.C., HOUSTON, TX (US)

(72) Inventor: Kenneth E. Welker, Oslo (NO)

(73) Assignee: WESTERNGECO L.L.C., HOUSTON, TX (US)

(21) Appl. No.: 14/350,823

(22) PCT Filed: Oct. 11, 2012
(86) PCT No.: PCT/US2012/059641

§ 371 Date: Apr. 10, 2014

Related U.S. Application Data
(60) Provisional application No. 61/545,969, filed on Oct. 11, 2011.

(51) Int. Cl. G01V 1/38; G01S 11/14

(52) U.S. Cl. CPC G01V 1/3835; G01S 11/14
USPC 367/16; 367/118

(57) ABSTRACT

A method of acoustic positioning determination includes detecting a temperature gradient profile across a depth of water, determining a level of a thermal boundary between an upper temperature level and a lower temperature level, and determining a distance from the thermal boundary to position the acoustic positioning device and positioning the acoustic positioning device at that location.

### TECHNICAL FIELD

The present application relates to marine seismic exploration, and more particularly to marine seismic acoustic positioning of seismic exploration equipment with respect to temperature gradients across depths.

### BACKGROUND

Marine seismic exploration can involve the use of seismic streamers that are towed by vessels. The streamers can be elongated tubular structures that support various seismic sensors therein. They also can include various electronics for communications relating to the seismic signals detected. A source such as an air gun or vibrator is used to generate a source signal. The source signal propagates though the water into the seafloor formation where it is reflected. The seismic sensors in the streamers detect that reflection and use the reflected signals, in conjunction with timing and position information to generate a plot indicating attributes of the underlying surface formation.

In connection with the towed streamers are floats that are generally connected near the front of the streamer. This can be by way of a cable, cord, rope, chain or other connecting device. The floats can also be connected at the tail end of the streamers. The floats could also be connected at a mid-point of a streamer. The floats are buoyant and can hold the streamers at a depth. The floats can also have connected therewith acoustic positioning devices (e.g., sources, receivers, and/or transducers). Acoustic positioning devices can also be connected with a vessel. The acoustic positioning devices can also be connected at various portions of the streamers. The acoustic positioning devices can emit acoustic signals that are detected by sensors on the streamer and are used to determine the position of the sensors on the streamer. Also, the acoustic positioning devices can receive acoustic positioning signals. The positioning devices can also be a combination of emitter and receiver of acoustic positioning signals. Based on the time the signal is emitted and the time the signal is received by a sensor, a distance can be calculated. Based on distances, the position of the sensor can be calculated with triangulation. This is possible when the position of the acoustic positioning device(s) is known. A global positioning system (GPS) can be connected with a positioning devices (or associated support structure like a vessel or float) to provide location of the positioning devices. The positioning devices are normally close to the surface of the water when connected with a float or a vessel. Acoustic positioning devices can be located on the streamers.

There are various aspects of the ocean environment in which these surveys are conducted that interfere or disrupt the acoustic signals transit thereby causing issues for the data integrity and the position determination of the sensors and in turn the streamer. Accordingly the present application provides a number of embodiments that address some of those issues.

### SUMMARY

The following is a summary of various embodiments of the present application. It is not meant in any way to unduly limit any present or future scope of claims related to this application.

A method of acoustic positioning determination includes detecting a temperature gradient profile across a depth of water, determining a level of a thermal boundary between an upper temperature level and a lower temperature level, and determining a distance from the thermal boundary to position the acoustic positioning device and positioning the acoustic positioning device at that location.

### BRIEF DESCRIPTION OF THE FIGURES

The following brief description of the figures is meant to help one skilled in the art better understand the various embodiments described herein. They are not meant in any way to unduly limit any present or future related claims in connection with this application.

FIG. 1 shows a schematic view of various embodied features.

FIG. 2 shows a schematic view of various embodied features.

FIG. 3 shows a schematic view of various embodied features.

FIG. 4 shows a schematic view of various embodied features.

FIG. 5 shows a chart illustrating temperature gradients.

FIG. 6 shows a chart illustrating a temperature gradient.

FIG. 7 shows an illustration describing the effect of temperature gradients on sound transmission and travel in water.

### DETAILED DESCRIPTION

The following description concerns a number of embodiments and is meant to provide an understanding of the embodiments to one skilled in the art. The description is not in any way meant to limit the scope of any present or subsequent related claims.

In a marine seismic survey, a vessel tows seismic streamers. One or more seismic streamers can be towed. The streamers can be directly connected with a tow vessel or have an intermediary connector. For the purposes of the application, it will be understood that this intermediary connector is possible but that the streamer plus the intermediary will be simply referred to as a streamer. The intermediary can include a series of connectors that make up the front portion of the spread, for example deflectors that force the front part of the spread into a wide configuration. The intermediary is much shorter in comparison to a streamer and does not generally poses seismic sensors and acoustic survey equipment as the streamer does. An embodiment of a towed spread could be four, six, eight or more streamers spaced laterally from one another. A seismic source is provided to generate an acoustic signal. The source can be an air gun, or could be a vibrator. The source can be interconnected with the spread or the vessel towing the seismic streamer spread. Also, the source could be separate from the spread and connected with a vessel different than the tow vessel. There can be one or more acoustic sources.

The depth of the seismic streamer spread can be controlled. One way to control the seismic streamer spread is with steering devices that connects with the streamer. One such steering device is a fin steering device known as the Q-fin. This is provided commercially by WesternGeco. There are other commercial steering devices on the market for steering streamers. The steering can be lateral and/or vertical. The shape of the streamer can also be controlled by the steering. In the vertical reference, one part of the streamer can be at one depth and another part of the streamer can be at another depth. The shape of the streamer can be an “S” shape or can be a single curve. Another option is to use buoyancy to control the depth that the streamer is towed.

As part of a seismic survey the position of the streamer is determined. One way to determine the position of the streamer is to determine position of various sensors along the streamer. Based on determination of the various points on the streamer, the shape of the streamer can be determined.

One way to make these position determinations is by emitting acoustic positioning signals from a positioning deice and detecting those signals with sensors on the streamer. The sensors that receive the signal can be on the streamer. The reverse can be used too, where the signal is produced on the streamer and is received by the positioning device. From determining the travel time of the positioning acoustic signals from a known position, the distance between the positioning device and the position on the streamer can be determined. Two or more positioning acoustic devices can be used. With two or more acoustic positioning devices the position of a sensor (or source of acoustic signal) on the streamer can be triangulated.

The float can have a GPS connected thereto and associated electronics. Other devices can be used in place of the GPS, including optical and other wireless range/positioning devices. Also the float can communicate to receive signals to command action such as transmission of the acoustic positioning signal.

Plural floats can be coordinated to provide two or more acoustic positioning signals. Also, a positioning signal from an acoustic positioning device connected with the tow vessel can be used. The acoustic positioning signals are detected by the streamer sensors and are used to determine the position of the streamer with respect to the floats and/or vessel where the position of the floats and/or vessel is known by way of a device such as a GPS. In turn, the shape of the streamer can be determined based on the position of various points (sensors) on the streamer.

Issues with acoustic positioning can develop due to temperature boundary gradients in the water. In the summer time the upper levels of the water can be warmer than the lower levels of the water. Conversely, in the winter months the upper levels of the water can be colder than the lower levels of the water. A temperature gradient can develop that affects the speed of travel for the acoustic position signal depending on depth. This boundary will also refract the sound. If the difference in travel time/speed and/or refraction is not accounted for, the accuracy of the determined position and shape of the streamer can be negatively affected because the distance/position calculations will be inaccurate. At certain depths, this issue can be magnified or worsened compare to other depths. Thus, it can be beneficial to position the acoustic positioning device and the sensors on the streamer at a position spaced from the certain troublesome depths. For example, the depth to be avoided could be close to or across the sharpest point of the temperature gradient.

One way to address that issue is by locating the temperature gradient. This can be done in various ways such as lowering a temperature sensor in the water and detecting the temperature. Once a temperature gradient is determined, the acoustic positioning device and the streamer can be positioned at a depth that is sufficiently far above or below the temperature gradient, to reduce the impact the gradient has on the travel of the acoustic positioning signal, thus reducing any negative effect on the seismic survey.

According to an embodiment, a float includes an acoustic positioning device that is adjustable with respect to depth. One way to adjust that depth is by connecting the positioning device to an extendable/retractable support member that is connected with the float. This extendable/retractable support member can be telescopic and can extend downward from the float. The positioning device can also be connected with a cord or other member connecting the float to the streamer. The positioning device can travel and be located long the cord or member at various positions to change the depth of the source. Further, the depth of the streamer can be changed by way of a steering device such as steering fins (e.g., the Q-fin that is commercially provided by WesternGeco).

Where the acoustic positioning device is on a tow vessel (or other vessel), a similarly adjustable support member can be used to adjust the depth at which the positioning device is located. In any event, there are number of different way to adjustably locate the positioning device at a desired depth.

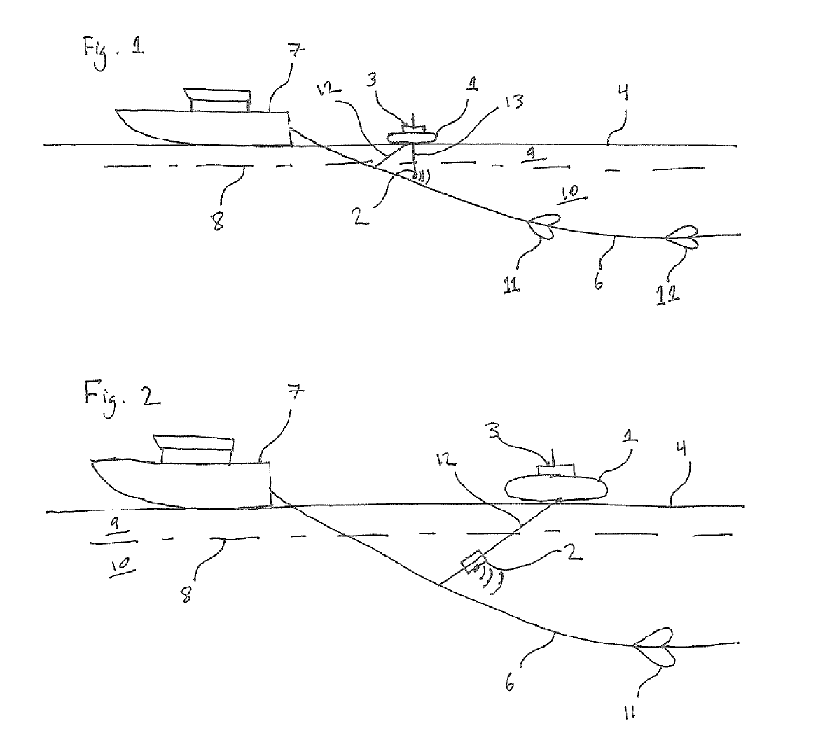

Now looking at the figures, FIG. 1 shows a float 1 having connected thereto an acoustic positioning device 2. A GPS 3 is connected to the float 1 and can communicate/determine position of the float 1. A streamer 6 is connected with the float 1 by way of a connector 12. The connector can be rope, chord, cable, chain or other connector. It could be a rigid member. The streamer 6 can be connected to a tow vessel 7. Numerous different configurations are available so long as the position of the float 1 with respect to the streamer 6 can be determined to an acceptable accuracy. A temperature gradient 8 is shown and the positioning device 2 and the streamer 6 are below the gradient 8.

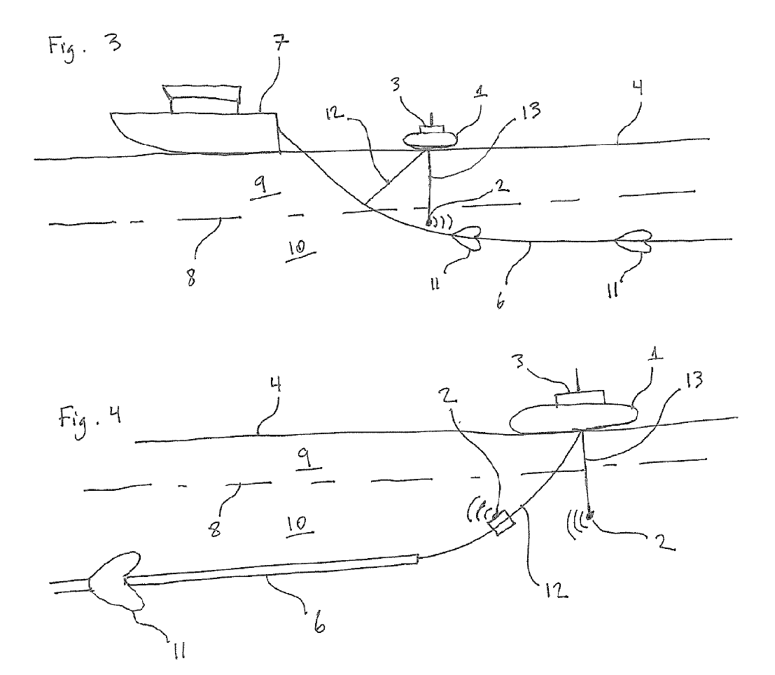

FIG. 2 shows a temperature gradient 8 that is a certain distance from the surface 4 of the water. The upper level of the water 9 is separated from the lower level of the water 10 by the temperature gradient. The upper level of the water 9 can be of a greater temperature than the lower level of the water 10. Conversely the upper level of the water 9 can be a lower temperature than the lower level of the water 10. FIG. 5 shows a sound velocity in different areas of the water in summer or winter time. Water temperature affects the velocity sound travels in the water. As illustrated there, at a defined temperature gradient (where the temperature change is emphasized), the change in sound velocity is pronounced. This will also cause refraction of the sound signal.

According to various embodiments, the depth of the temperature gradient 8 can be determined. One way is to take temperature measurements at different depths. Another is to reference prior collected date or records to determine a likely depth for the temperature gradient. FIG. 5 shows a temperature gradient for a particular body of water could be used as reference to determine with good accuracy the temperature gradient.

The streamer 6 can be positioned at a determined depth that is adequately above or below the temperature gradient 8. Also, the acoustic positioning device 2 can be positioned at an adequate distance above or below the temperature gradient 8. Normally, the acoustic positioning device 2 will be positioned on the same side of the temperature gradient 8 as the streamer 6.

As shown in FIG. 2, the acoustic positioning device 2 can be position on the connector 12 so that it is at a similar depth as the streamer 6. The positioning device 2 can be movable along the connector 12. This movement can be by way of an electric motor. The movement can also be created by connecting a line to the positioning device 2 and pulling the cord into position. The depth of the streamer 6 and the depth of the positioning device 2 can be the same or similar. As the streamer 6 is set to a depth above or below the temperature gradient 8, the acoustic positioning device 2 will be on the same side of the gradient 8. FIG. 2 shows that the positioning device 2 and the streamer 6 are below the temperature gradient 8. Of course since the streamer 6 connects with the tow vessel there is a portion of the streamer 6 that is above the gradient 8, but in the context of the present application it is meant to refer to the majority of the streamer 6.

FIG. 1 shows steering fins 11 connected with the streamer 6. The fins 11 can be vertical or horizontal, or a combination of both orientations, to steer the streamer 6 in the vertical and/or horizontal direction. The fins 11 can be rotatable around the axis of the streamer 6 so as to be able to rotate between the horizontal and vertical position.

FIG. 3 shows the float 1 with a member 13 extending below the float 1. The member 13 supports an acoustic positioning device 2. The member 13 can be extendable/retractable. The member 13 can be telescoping in configuration. The member 13 can be configured so that the positioning device 2 moves up and down along to the member 12 to be positioned at a desired depth. The member 13 can be positioned to locate the positioning device 2 at a depth that is commensurate with the depth of the streamer 6 so as to position the streamer 6 and the source on the same side of the temperature gradient 8. Also, the positioning device 2 and the streamer 6 can be positioned a certain distance from the temperature gradient 8.

Another source of interference and issues with the acoustic positioning signal is the surface of the water 4. Waves and other surface actions such as reflections and variances can disrupt the continuity of the travel from the positioning device 2 to the sensors on the streamer 6. If the positioning device 2 is too close to the surface 4, the signal can be reflected and otherwise have the velocity or travel path disrupted. This is detrimental to the accurate determination of the streamer 6 position. Accordingly, the depth of the positioning device 2 can be far enough from the surface of the water 4, and the depth of the streamer 6 can be sufficiently deep so as to reduce the interference caused by the surface of the water.

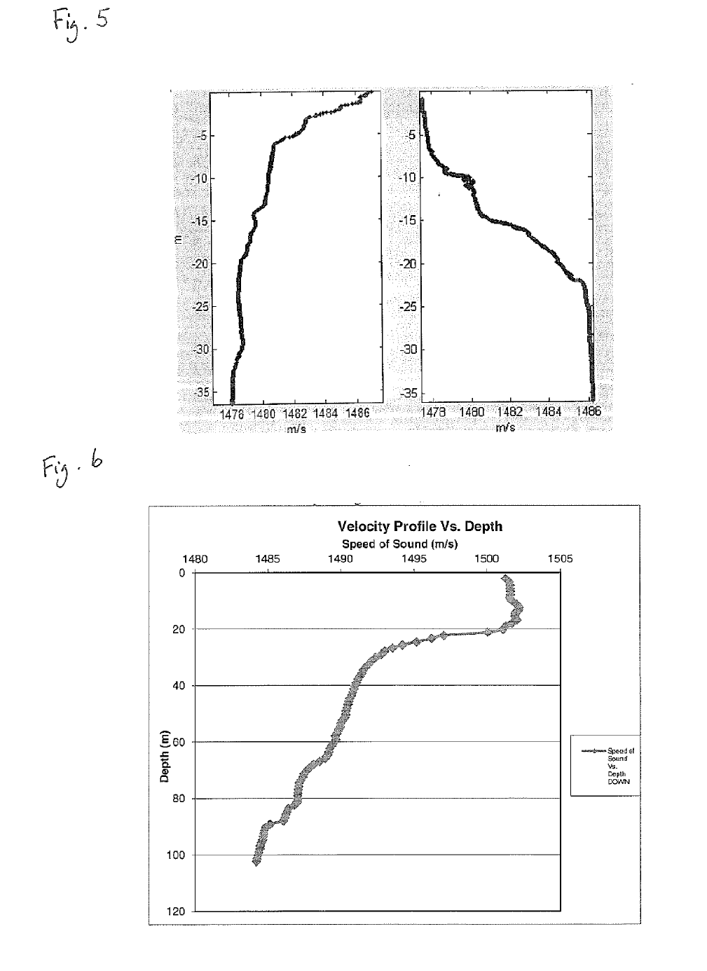

FIG. 4 shows a float 1 connected with a tail end of a streamer 6. The connection is by way of a connector 12. A steering device 11 is connected with the streamer 6. Two positioning devices 2 are shown, one positioning device 2 being connected along the connector 12 and movable along the connector 12. Another positioning device 2 is connected by the member 13 to the float 1. A GPS 3 is located on the float 1. The positioning devices 2 and the streamer 6 are both located below the temperature gradient 8.

It should be understood that the sensors on the streamer 6 that are used for the preceding described positioning can be incorporated within the structure of the streamer 6, can be attached externally to the streamer 6, can be incorporated with the steering device 11, and can be connected to the streamer in numerous envisioned ways.

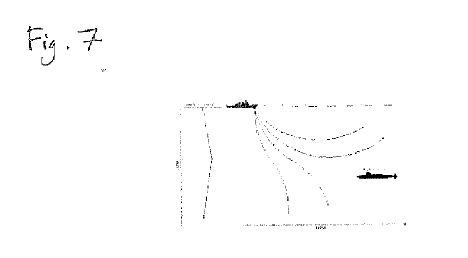

FIG. 5 shows a sound velocity profile for a body of water where the left side shows the profile in summer and the right side shows the profile in winter. FIG. 6 shows a sound velocity profile for an area of seismic surveying in the North Sea in summer. The negative gradient starting at about 20 meters causes the acoustic energy of a transmitter to be reflected downwards and away from receivers above a positioning transmission device.

These actions are covered by Snell's law explaining refraction, which is represented by the following equation:

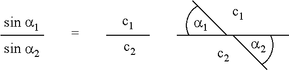

FIG. 7 illustrated the effect the variance of velocities of sound and the resulting refraction as described above can have with respect to a source and possible reception positions. It is quite clear that issues would result from transmission of an acoustic position source to a sensor when the temperature gradient is involved.

The preceding description is meant to provide assistance to one skilled in the art in understanding the various embodiments described herein. It is not meant in any way to unduly limit any present or future claims associated with this application.

1. A method of acoustic positioning determination, comprising:
detecting a temperature gradient profile across a depth of water;
determining a level of a thermal boundary between an upper temperature level and a lower temperature level; and
determining a distance from the thermal boundary to position the acoustic positioning device and positioning the acoustic positioning device at that location.

2. The method of claim 1, comprising providing a float that has connected thereto a support for the acoustic positioning device that is extendable and retractable to adjust the distance from the float that the transceiver is held from the float device.

3. The method of claim 2, wherein the support for the acoustic positioning device is a rigid structure extending below the float.

4. The method of claim 3, wherein the rigid structure is adjustable in length extended below the float.

5. The method of claim 4, wherein the support is telescoping in design.

6. The method of claim 2, wherein the support is a connector that extends from the float to the streamer and the acoustic positioning device is movable along the connector to vary the depth of the acoustic positioning device.

7. The method of claim 1, comprising locating the acoustic positioning device and the streamer below the thermal boundary.

8. The method of claim 1, comprising locating the acoustic positioning device and the streamer above the thermal boundary.

9. A method of locating position determination, comprising:
locating an acoustic positioning device at a first depth and performing an acoustic position determination;
determining the quality of the acoustics;
adjusting the depth of the acoustic positioning device based on those determinations.

10. The method of claim 9, comprising determining the depth of a thermal boundary.

11. The method of claim 10, comprising positioning the acoustic positioning device at a location above the thermal boundary.

12. The method of claim 11, comprising steering a streamer so that the streamer is located at a position above the thermal boundary.

13. The method of claim 10, comprising positioning the acoustic positioning device a distance below the thermal boundary.

14. The method of claim 13, comprising steering the streamer to be at a distance below the thermal gradient.

15. The method of claim 13, comprising steering the streamer so that at least a portion of the streamer is at the same depth as the acoustic positioning device.

16. A seismic survey apparatus, comprising:
a survey vessel;
a streamer connected to the survey vessel so that the survey vessel tows the seismic streamer;
a float connected to the streamer; and
the float having connected thereto a seismic positioning device, the distance between the float and the seismic positioning device in a downward direction being adjustable.

17. The apparatus of claim 16, comprising a steering device connected with the streamer, the steering device comprising at least two fins that are adapted to steer the streamer.

18. The apparatus of claim 16, comprising a support that connects between the float and the seismic positioning device, the support being extendable.

19. The apparatus of claim 16, wherein a member connects between the float and the streamer and the seismic positioning device connects to the member in a manner so that the seismic positioning device can be located at various positions longitudinally along the member to vary the depth of the acoustic positioning device.

20. The apparatus of claim 16, wherein the float is connected with a front portion of the streamer.

21. The apparatus of claims 16, wherein the float is connected with a tail portion of the streamer.
